(19) United States
(12) Patent Application Publication
(10) Pub. No.: US 2026/0210990 A1
(43) Pub. Date: Jul. 23, 2026

(54) LABWARE REPOSITIONING SYSTEM

(71) Applicant: Nucleus Automation Partners, LLC, Jarrell, TX (US)

(72) Inventor: Michael Mueller, Jarrell, TX (US)

(73) Assignee: Nucleus Automation Partners, LLC, Jarrell, TX (US)

(21) Appl. No.: 19/033,952

(22) Filed: Jan. 22, 2025

(51) Int. Cl. G01N 35/10

(52) U.S. Cl. CPC G01N 35/1011; G01N 35/1074; G01N 35/1083

(57) ABSTRACT

A labware repositioning system includes a motor having a rotatable shaft, a labware holder having a surface configured to hold a labware, and connected to the rotatable shaft, and a controller operatively connected to the motor and configured to control rotation of the rotatable shaft, and the attached labware holder. The controller is configured to rotate the labware holder and the labware positioned thereon to any desired number of rotational positions.

### BACKGROUND OF THE INVENTION

This invention relates in general to robotic liquid handling systems for performing tasks in laboratory environments. In particular, this invention relates to an improved labware repositioning system configured to move the labware between a plurality of positions.

Conventional robotic liquid handling systems include robotic pipettes for dispensing liquids, and gripper arms for manipulating labware, such as plates. A conventional pipette arm may be moved to a stationary plate to perform an aspirate or a dispense function. In many known embodiments, the robotic pipette may be configured as a single-channel pipette or a multi-channel pipette, for example a 2-channel, 4-channel, 8-channel, 12-channel, or 16-channel pipette. The pipette channels are traditionally oriented in a linear fashion, in many cases aligned in a column. For example, an 8-channel pipetting arm is able to aspirate or dispense simultaneously from a single column of rows A to H of a 96-well plate. The ability to pipette to multiple channels wells of the plate at once provides advantages in terms of speed and throughput.

Despite these advantages, certain assays use suboptimal plate organization which may not maximize the benefit of the throughput of the multiple channel orientation along the column. For example, the plate layout may use rows rather than columns. Many liquid handling pipettes that are configured to aspirate or dispense along a column are unable to reorient the channels to aspirate or dispense from multiple channels across a row at the same time. In this situation, the systems must resort to using a single-channel to aspirate or dispense across a row at a given time. This reduction in channel utilization slows down the processing of the plate and the performance of the assay. In addition, the reduction in channel utilization has the potential to introduce detrimental and disadvantageous effects on assay performance due to timing effects that may introduce bias into the system, or the data collected.

Some liquid handling systems, such as integrated work cells, have limitations in the way in which plates are brought into the system. For example, a plate with well A1 oriented at the top left may be introduced into the liquid handler by a shuttle system. The liquid handler gripper arm may have limitations in its ability to approach the plate on the shuttle such that it can only approach from one side, for example the right side. However, the desired well in the plate may only be approachable by the gripper from the opposite side, for example the left side.

This limitation creates a situation where the plate must be re-oriented. For example, well A1, which was previously top left, may be relocated to the bottom right. This scenario introduces complexities in sample tracking and may, if overlooked, lead to a sample being transferred to an incorrect or unintended well of the plate. Traditionally, this situation is mitigated by use of a “re-grip” position, a location where the gripper arm is able to access the location from multiple orientations. For example, the gripper arm may pick up the plate, re-orient it, and set it back down to re-align well A1 to the desired orientation. However, in some cases, such as highly integrated systems, a re-grip position may not be available, or height differences of adjacent labware may restrict access to the re-grip position. In some instances, the gripper arm may fail and drop the plate. Such occurrences may result in a loss of sample, or in aborted instrument runs. In some applications, reagent or sample costs are high, leading to significant financial loss from a dropped plate, or other labware, and an ability to mitigate risks by reducing or eliminating the number of times that sample plates are gripped is beneficial.

Thus, it would be desirable to provide an improved labware repositioning system configured to move the labware between a plurality of positions without requiring the labware to be re-gripped.

### SUMMARY OF THE INVENTION

This invention relates to an improved labware repositioning system configured to move the labware between a plurality of positions. The labware repositioning system includes a motor having a rotatable shaft, a labware holder having a surface configured to hold a labware, and connected to the rotatable shaft, and a controller operatively connected to the motor and configured to control rotation of the rotatable shaft, and the attached labware holder. The controller is configured to rotate the labware holder and the labware positioned thereon to any desired number of rotational positions.

In another embodiment, the labware repositioning system includes a servo motor having a rotatable shaft, the rotatable shaft having a longitudinal axis. A cylindrical hub is mounted to the rotatable shaft. A labware nest assembly has a surface configured to hold a labware, and is connected to the cylindrical hub. A controller is operatively connected to the servo-motor and configured to control rotation of the rotatable shaft, and the attached labware nest assembly, wherein the controller is configured to rotate the combined labware nest adaptor to any desired number of rotational positions. A base plate has at least one servo motor mounted thereto. An infrared sensor mounting plate is mounted to the flange of the servo motor by spacers that are connected to the flange and the infrared sensor mounting plate. An infrared sensor is mounted to the infrared sensor mounting plate, wherein the infrared sensor includes a body having a first arm and a second arm, and is connected to an optical encoder. An alignment rod is mounted to either the labware nest assembly or the cylindrical hub, wherein the alignment rod extends transversely from the longitudinal axis of the servo motor and is configured to pass between the first and second arms of the infrared sensor when the hub and the attached labware nest assembly are caused to rotate. In operation, the controller is programmed to rotate the servo motor such that the labware positioned in the labware nest assembly is rotated about the longitudinal axis of the servo motor to any desired angular position relative to a longitudinal axis of the base plate, in either a clockwise or counterclockwise direction, and for any desired duration of time. Additionally, as the rotatable shaft of the servo motor rotates, the alignment rod passes between the first and second arms of the infrared sensor, thus allowing the connected optical encoder to define a reference point that establishes a home position for the combined labware nest adaptor and the labware positioned therein. A power supply is connected to the servo motor, the controller, and the infrared sensor.

In an additional embodiment, a robotic liquid handling system includes a plurality of labware repositioning systems. Each labware repositioning system includes a servo motor having a rotatable shaft, the rotatable shaft having a longitudinal axis, a cylindrical hub, and a labware nest assembly having a surface configured to hold a labware, and connected to the rotatable shaft, wherein the cylindrical hub is mounted to the rotatable shaft and to the labware nest assembly. A controller is operatively connected to the servo-motor and configured to control rotation of the rotatable shaft, and the attached labware nest assembly, wherein the controller is configured to rotate the labware nest assembly to any desired number of rotational positions. At least one servo motor is mounted to a base plate. An infrared sensor mounting plate is mounted to the flange of the servo motor by standoffs that are connected to the flange and the infrared sensor mounting plate. An infrared sensor is mounted to the infrared sensor mounting plate, wherein the infrared sensor includes a body having a first arm and a second arm, and is connected to an optical encoder. An alignment rod is mounted to either the labware nest assembly or the cylindrical hub, wherein the alignment rod extends transversely from the longitudinal axis of the servo motor and is configured to pass between the first and second arms of the infrared sensor when the hub and the attached labware nest assembly are caused to rotate. In operation, the controller is programmed to rotate the servo motor such that the labware positioned in the labware nest assembly is rotated about the longitudinal axis of the servo motor to any desired angular position relative to a longitudinal axis of the base plate, in either a clockwise or counterclockwise direction, and for any desired duration of time. Additionally, as the rotatable shaft of the servo motor rotates, the alignment rod passes between the first and second arms of the infrared sensor, thus allowing the connected optical encoder to define a reference point that establishes a home position for the labware nest assembly and the labware positioned therein. A power supply is connected to the servo motor, the controller, and the infrared sensor.

Various aspects of this invention will become apparent to those skilled in the art from the following detailed description of the preferred embodiment, when read in view of the accompanying drawings.

### BRIEF DESCRIPTION OF THE DRAWINGS

FIG. 1 is a schematic side elevation view of an embodiment of the improved labware repositioning system according to the invention.

FIG. 2 is a plan view of the carrier plate shown in FIG. 1.

FIG. 3 is a plan view of the adaptor plate shown in FIG. 1.

FIG. 4 is a plan view of the infrared sensor mounting plate shown in FIG. 1.

FIG. 5 is a plan view of the carrier plate shown in FIGS. 1 and 2 showing two of the improved labware repositioning systems mounted thereon.

FIG. 6 is a plan view of a conventional 96-well microwell plate.

FIG. 7 is a top plan view of a conventional plate nest.

FIG. 8 is a perspective view of an alternate embodiment of the base plate illustrated in FIGS. 1, 2, and 5 and showing the microwell plate, but shown without the improved labware repositioning system for clarity.

FIG. 9 is a schematic side elevation view of an alternate embodiment of the improved labware repositioning system according to the invention, showing an alternate embodiment of the alignment rod.

### DETAILED DESCRIPTION OF THE PREFERRED EMBODIMENT

In order for the present disclosure to be more readily understood, certain terms are first defined below. Additional definitions for the following terms and other terms are set forth throughout the specification.

Assay: The term “assay” refers to one of a broad range of laboratory processes, including but not limited to extracting DNA from samples, preparing DNA libraries for genetic sequencing, and finding and measuring the amount of a specific substance.

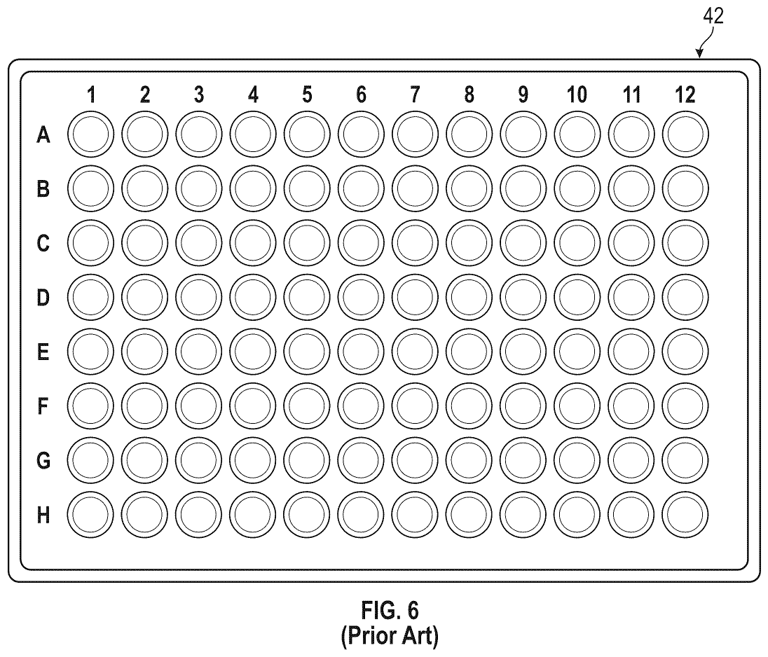

Labware: The term “labware” refers to a multi-well microwell or microtiter plate, such as a 96-well or 384-well microplate, a Petri dish, an agar plate, a 24-well plate, a 48-well plate, a 6-well plate, a holder of tubes, or other fixture for holding objects subject to being aspirated or having liquid dispensed therein. An example of a conventional 96-well microplate is shown at 42 in FIG. 6. The illustrated 96-well microplate 42 has eight rows and 12 columns. An ANSI standard defines the dimensional requirements of the footprint of a microplate, such as the microplate 42. In accordance with the ANSI standard, the required outside dimension of the footprint of the microplate 42 is: length 127.76 mm +/−0.5 mm, and width 85.48 mm +/−0.5 mm.

Known robotic liquid handling systems typically include a worktable having means for storing labware, such as the plate 42, and means for moving pipettes, such as a gantry. One or more labware carriers, often configured as holders, are positioned at different heights, or distances from the worktable. Plate nests, within which the plates 42 are seated, may be permanently or movably mounted to the labware carriers.

A robot having a robotic gripper arm is provided and configured to move the plates 42. A channel arm with a desired channel pipette, such as a 2, 4, 8, 12, or 16 channel pipette, is also mounted to, or is a component of, the robot. A controller is provided and is configured to control movement of all moving components of the liquid handling system, such as the gripper arm and the channel arm. One example of such a robotic liquid handling system is the Tecan Fluent® liquid handler manufactured by Tecan Trading AG, Switzerland.

Typically, in known robotic liquid handling systems, if the pipette channels are setup as a column, they cannot simultaneously dispense in a row pattern. However, it is possible, for example, to pickup in a column with 8-channels from one labware, then dispense using the 8-channels to a row, e.g., wherein channel 1 dispenses to well A1, channel 2 dispenses to well A2, channel 3 dispenses to well A3, etc., but each channel dispenses at a different time, not simultaneously. Some users of known robotic liquid handling systems may position a plate or plates in a way that defines a row-pattern. This is inefficient as it often forces the use of just a single pipette channel at a time.

There are labware carriers in known robotic liquid handling systems that are positioned such that the plates are static and in a portrait format, i.e., wherein each row of the plate is parallel to the pipette channel column. A robotic gripper arm may be provided and configured to grip, lift, and move a plate 42 between one or more positions on the labware carrier. However, such gripper arms may not be reliable, and users may not trust the gripper arm to move a plate, especially a plate having expensive reagents therein. As will be described herein, use of the illustrated labware repositioning system avoids the need to change the nest.

Additionally, in some known robotic liquid handling system configurations, adjacent labware carriers may be positioned at different heights, thus restricting the direction from which the gripper arm may approach and grip a plate. Although the gripper arm may be able to grip the plate from any side of the plate, height differences, such as between adjacent labware carriers and between the gripper arm and the labware carriers, may restrict such access and require the use of an external position, or regrip station.

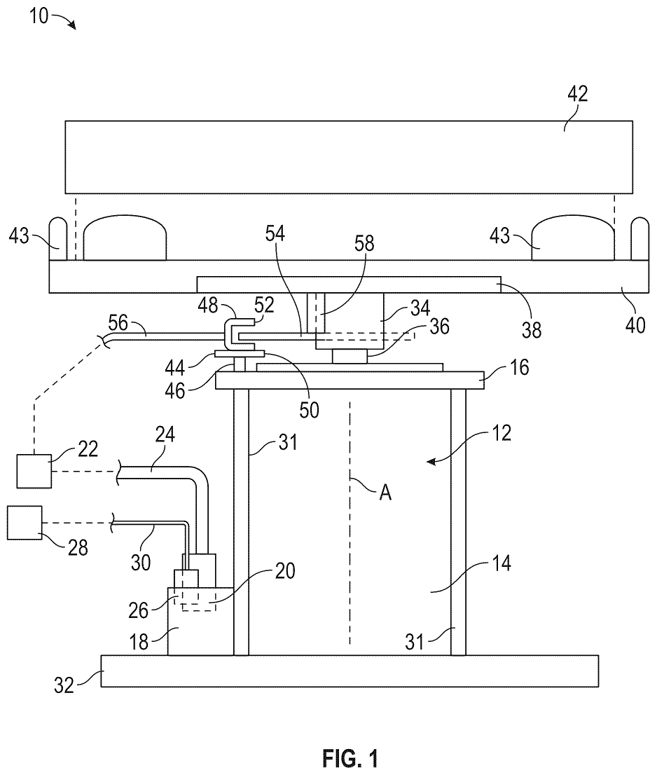

Referring now to the drawings, there is shown in FIG. 1 a schematic illustration of an improved labware repositioning system 10 configured to be mounted to, and operated as part of, a robotic liquid handling system carrier, and further configured to move labware between a plurality of positions in the robotic liquid handling system.

The illustrated labware repositioning system 10 includes a servo motor 12. One example of a suitable servo motor is a Teknic Clearpath® integrated servo motor manufactured by Teknic, Inc. of Victor, NY. Such an integrated servo motor may include an embedded motion controller, a brushless permanent magnet motor, a high-resolution encoder, and digital servo electronics. It will be understood that other types of motors may also be used, including but not limited to other types of servo motors and stepper motors.

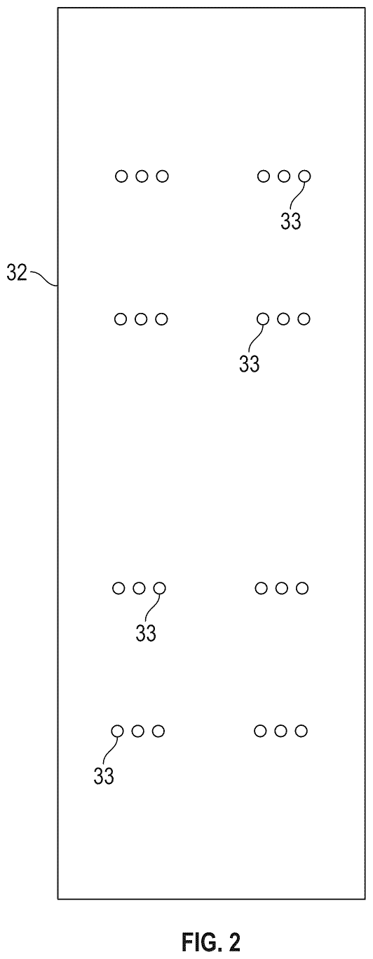

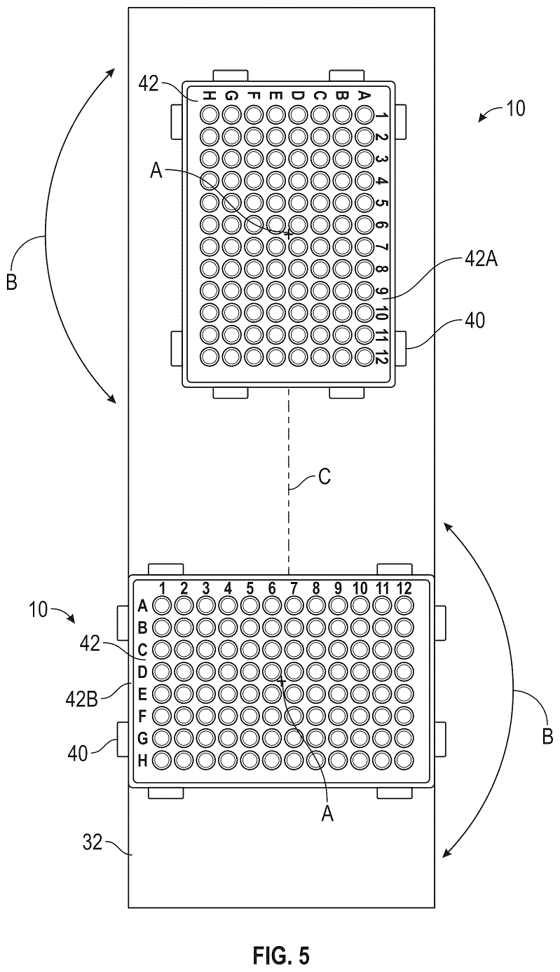

The illustrated servo motor 12 includes a motor body 14, a flange 16 at a first end thereof (the upper end when viewing FIG. 1), and a connector portion 18 having ports, such as an electrical power port 20 for connection to a power supply (schematically illustrated at 22), or other source of electricity, via an electrical cable 24, and an encoder port, such as a USB port 26, for connection to a controller (schematically illustrated at 28) via a USB cable 30. The servo motor 12 is mounted to a base or carrier plate 32, also shown in FIGS. 2 and 5, by standoffs 31 that are connected to the flange 16 and the carrier plate 32, such as with threaded fasteners. The illustrated carrier plate 32 includes a plurality of mounting holes 33 formed therein. The carrier plate 32 may be formed from metal, including, but not limited to, aluminum, steel, stainless steel, Delrin, ceramic, 3D printed materials such as plastics, ABS, polycarbonate, nylon, Teflon, copper, polypropylene, and titanium, and may have a thickness of about 6 mm, although the carrier plate 32 may be formed having other thicknesses.

The illustrated carrier plate 32 is generally rectangular, although it may have other geometric shapes. Additionally, the carrier plate 32 may have any desired size. For example, the carrier plate 32 illustrated in FIG. 5 has a size configured to have two labware repositioning systems 10 mounted thereon. It will be understood however, that depending on the application, for example the size and type of the robotic liquid handling system with which the labware repositioning system 10 is used, other configurations are possible. For example, each carrier plate 32 may have a size configured to have one labware repositioning system 10 mounted thereon, or may have a size configured to have two or more labware repositioning systems 10 mounted thereon.

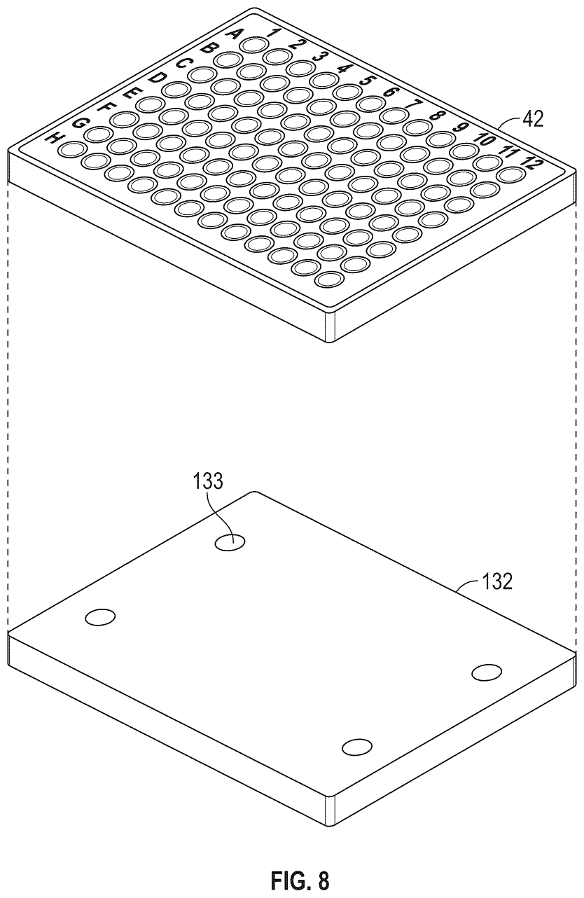

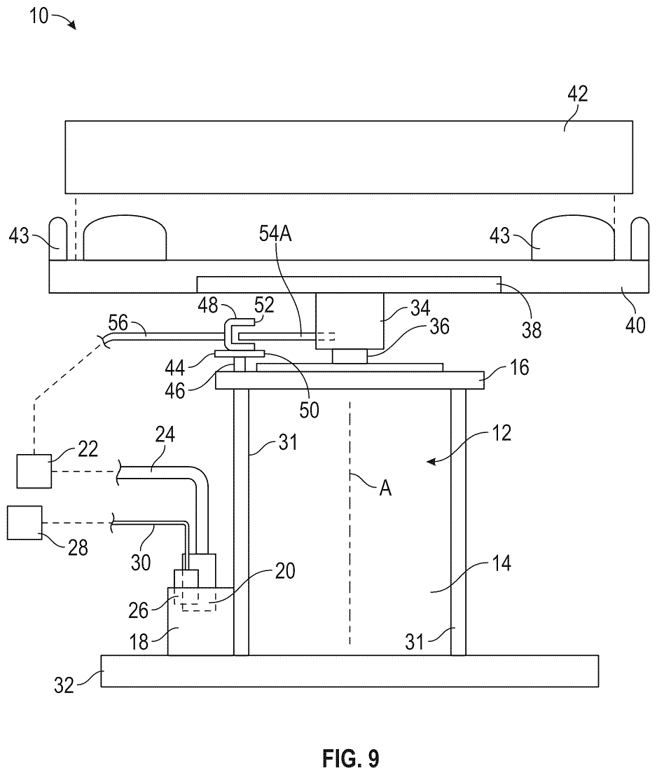

An alternate embodiment of the carrier or base plate is shown at 132 in FIG. 8. The base plate 132 includes four mounting holes 133 for attachment of the standoffs 31 (not shown in FIG. 8, but the same as the standoffs 31 shown in FIG. 1). The base plate 132 is otherwise similar to the carrier plate 32, except for its dimensions. The base plate 132 has the same outside dimensions as the footprint of the microplate 42, i.e., a length of 127.76 mm +/−0.5 mm, and a width of 85.48 mm +/−0.5 mm. Because the base plate 132 has the same outside dimensions the footprint of the microplate 42, the base plate 132 may be set on and/or mounted to any liquid handler that is already configured to accept an ANSI standard microplate by conforming the size of the base plate 132 to the microplate size.

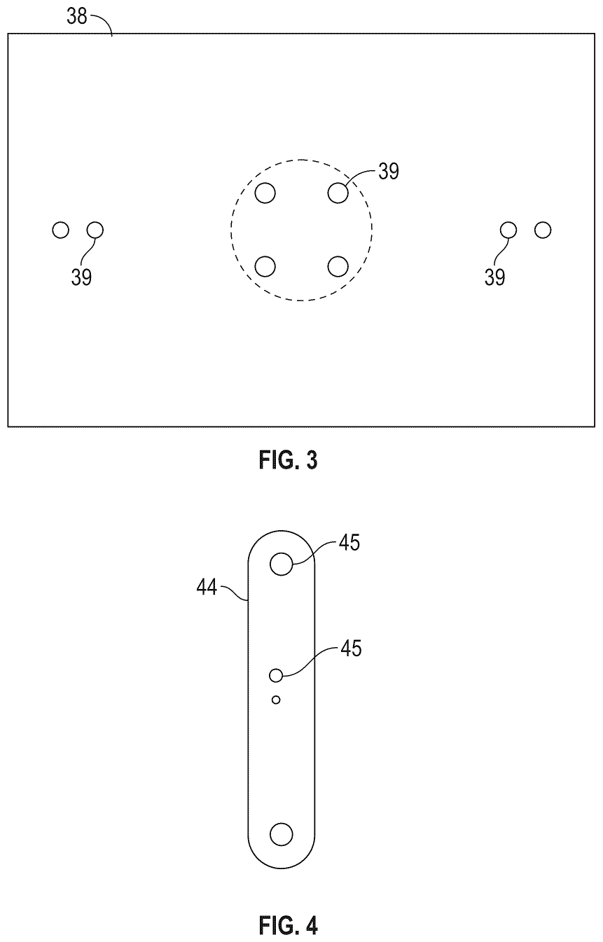

A cylindrical hub 34 is mounted to a rotatable shaft 36 having a longitudinal axis A, and to an adaptor plate 38, also shown in FIG. 3, such as with threaded fasteners. The illustrated adaptor plate 38 includes a plurality of mounting holes 39 formed therein, and is configured to have a labware nest or plate nest 40 mounted thereon, such as with threaded fasteners.

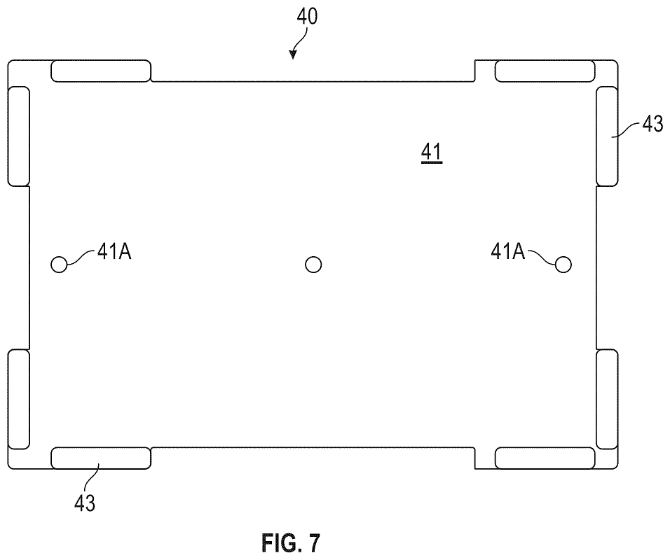

Alternatively, the labware repositioning system 10 may include a labware holder assembly (not shown). The labware holder assembly includes the features of the plate nest 40 as shown in FIG. 7, and the features of the adaptor plate 38, including the mounting hole 39, as shown in FIG. 3.

The adaptor plate 38 may be formed from metal, including, but not limited to, aluminum, steel, stainless steel, Delrin, ceramic, 3D printed materials such as plastics, ABS, polycarbonate, nylon, Teflon, copper, polypropylene, and titanium, and may have a thickness of about 3 mm, although the adaptor plate 38 may be formed having other thicknesses.

The plate nest 40 includes a mounting surface 41 having a plurality of mounting holes 41A formed therein. Tabs 43 extend outwardly from each side of the plate nest 40 and are configured to position and retain the plate 42 therein.

The labware illustrated in FIG. 1 is a 96-well microplate 42, and is positioned within the plate nest 40. It will be understood that other types of labware or plate nests that are configured to hold other types of labware or plates may also be used with the illustrated labware repositioning system 10.

An infrared sensor mounting plate 44, also shown in FIG. 4, is mounted to the flange 16 of the servo motor 12 by spacers 46 that are connected to the flange 16 and the infrared sensor mounting plate 44, such as with threaded fasteners. The illustrated infrared sensor mounting plate 44 includes a plurality of mounting holes 45 formed therein. The infrared sensor mounting plate 44 may be formed from metal, including, but not limited to, aluminum, steel, stainless steel, Delrin, ceramic, 3D printed materials such as plastics, ABS, polycarbonate, nylon, Teflon, copper, polypropylene, and titanium and may have a thickness of about 4.5 mm, although the infrared sensor mounting plate 44 may be formed having other thicknesses.

An infrared sensor 48 includes a body having a first arm 50 and a second arm 52 (the lower and upper arms respectively when viewing FIG. 1), includes an optical encoder, and is mounted to the infrared sensor mounting plate 44. An alignment rod 54 is mounted to the adaptor plate 38 by a standoff 58 that is connected to the adaptor plate 38, such as with threaded fasteners. The alignment rod 54 extends transversely from the axis A of the servo motor 12 and is configured to pass between the first and second arms 50 and 52 of the infrared sensor 48 when the hub 34 and its attached adaptor plate 38 are caused to rotate, as will be explained below. The infrared sensor 48 is connected to the power supply 22, or other source of electricity, by an electrical cable 56.

In an alternate embodiment of the labware repositioning system 10, the alignment rod 54A is attached directly to the cylindrical hub 34, such as by a threaded connection.

In operation, the controller 28 may be programmed to rotate the servo motor 12 in each of the labware repositioning systems 10, such that the microplate 42 positioned in the plate nest 40 is rotated about the axis A to any desired angular position relative to a longitudinal axis C of the carrier plate 32, and in either a clockwise or counterclockwise direction (see the arrows B).

FIG. 5 illustrates two plates 42A and 42B, such that the microplate 42A is in a first position wherein the rows A through H are oriented parallel to a pipette channel column (not shown). The plate 42B is in a second position wherein the columns 1 through 12 are oriented parallel to a pipette channel column (not shown). Advantageously, each microplate 42A and 42B may be easily and quickly rotated between the first and second positions, either separately or independently, and through as many rotations as desired. Additionally, each microplate 42A and 42B may be easily and quickly rotated to any other desired position.

As the servo motor 12 rotates, the alignment rod 54 passes through the infrared sensor 48, thus allowing the optical encoder to define a reference point that establishes a home position for the plate nest 40 and the microplate 42 therein.

Advantageously, the ability to rotate labware, such as the illustrated microplate 42 to any desired orientation relative to an associated channel arm allows the liquid handling process to be faster and more efficient than alternative processes wherein the labware cannot be moved or can only be moved with great difficulty, such as with a gripper arm.

Additionally, a lower deck of a robotic liquid handling system may advantageously be used to align the height of adjacent labware carriers so as to minimize any height disparities between adjacent labware carriers.

Thus, the labware repositioning system 10 described and illustrated herein mitigates disadvantageous limitations of known robotic liquid handling systems with its ability to change the orientation of the labware, i.e., the microplate 42, without requiring the microplate 42 to be re-gripped. This change in labware orientation is accomplished using the direct drive of the servo motor 12 to change, via rotation, the orientation of the microplate 42.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A labware repositioning system comprising:
a motor having a rotatable shaft;
a labware holder having a surface configured to hold a labware, and connected to the rotatable shaft; and
a controller operatively connected to the motor and configured to control rotation of the rotatable shaft, and the attached labware holder wherein the controller is configured to rotate the labware holder to any desired number of rotational positions.

2. The labware repositioning system according to claim 1, further including:
an adaptor plate; and
a cylindrical hub;
wherein the cylindrical hub is mounted to the rotatable shaft;
wherein the adaptor plate is mounted between the labware holder and the cylindrical hub; and
wherein the rotatable shaft has a longitudinal axis.

3. The labware repositioning system according to claim 1, wherein the controller is configured to rotate the labware holder and the labware positioned thereon to any desired number of rotational positions.

4. The labware repositioning system according to claim 2, wherein the motor is a servo motor including a motor body having a flange at a first end thereof; and
wherein the servo motor body includes an electrical power port for connection to a power supply, and an encoder port for connection to a controller.

5. The labware repositioning system according to claim 4, further including a base plate;
wherein at least one servo motor is mounted to the base plate.

6. The labware repositioning system according to claim 5, wherein the at least one servo motor is mounted to the base plate by standoffs that are connected to the flange and the base plate.

7. The labware repositioning system according to claim 6 wherein the labware holder and the adaptor plate are combined to define a labware holder assembly having the features of the labware holder and the adaptor plate.

8. The labware repositioning system according to claim 7, further including:
an infrared sensor mounting plate mounted to the flange of the servo motor by spacers that are connected to the flange and the infrared sensor mounting plate; and
an infrared sensor mounted to the infrared sensor mounting plate.

9. The labware repositioning system according to claim 8, further including an alignment rod mounted to the labware holder assembly by a standoff.

10. The labware repositioning system according to claim 8, further including an alignment rod mounted to the cylindrical hub.

11. The labware repositioning system according to claim 9, wherein the infrared sensor includes a body having a first arm and a second arm, and has an optical encoder connected thereto;
wherein the alignment rod extends transversely from the longitudinal axis of the servo motor and is configured to pass between the first and second arms of the infrared sensor when the hub and its attached adaptor plate are caused to rotate.

12. The labware repositioning system according to claim 11, wherein the labware is a multi-well microplate.

13. The labware repositioning system according to claim 1, wherein the labware repositioning system is configured to be mounted to, and operated as part of, a robotic liquid handling system.

14. The labware repositioning system according to claim 12, wherein in operation the controller is programmed to rotate the servo motor such that the multi-well microplate positioned in the plate nest is rotated about the longitudinal axis of the servo motor to any desired angular position relative to a longitudinal axis of the base plate, in either a clockwise or counterclockwise direction, and for any desired duration of time.

15. The labware repositioning system according to claim 14, wherein in operation as the rotatable shaft of the servo motor rotates, the alignment rod passes between the first and second arms of the infrared sensor, thus allowing the connected optical encoder to define a reference point that establishes a home position for the plate nest and the multi-well plate positioned therein.

16. A labware repositioning system comprising:
a servo motor having a rotatable shaft, the rotatable shaft having a longitudinal axis;
a cylindrical hub mounted to the rotatable shaft;
a labware nest assembly having a surface configured to hold a labware, and connected to the cylindrical hub;
a controller operatively connected to the servo-motor and configured to control rotation of the rotatable shaft, and the attached labware nest assembly, wherein the controller is configured to rotate the combined labware nest adaptor to any desired number of rotational positions;
a base plate, wherein at least one servo motor is mounted to the base plate;
an infrared sensor mounting plate mounted to the flange of the servo motor by spacers that are connected to the flange and the infrared sensor mounting plate;
an infrared sensor mounted to the infrared sensor mounting plate, wherein the infrared sensor includes a body having a first arm and a second arm, and is connected to an optical encoder;
an alignment rod mounted to one of the labware nest assembly and the cylindrical hub, wherein the alignment rod extends transversely from the longitudinal axis of the servo motor and is configured to pass between the first and second arms of the infrared sensor when the hub and the attached labware nest assembly are caused to rotate;
wherein in operation the controller is programmed to rotate the servo motor such that the labware positioned in the labware nest assembly is rotated about the longitudinal axis of the servo motor to any desired angular position relative to a longitudinal axis of the base plate, in either a clockwise or counterclockwise direction, and for any desired duration of time; and
wherein in operation as the rotatable shaft of the servo motor rotates, the alignment rod passes between the first and second arms of the infrared sensor, thus allowing the connected optical encoder to define a reference point that establishes a home position for the combined labware nest adaptor and the labware positioned therein; and
a power supply connected to the servo motor, the controller, and the infrared sensor.

17. The labware repositioning system according to claim 16, wherein the servo motor includes a motor body having a flange at a first end thereof; and
wherein the servo motor body includes an electrical power port for connection to the power supply, and an encoder port for connection to the controller.

18. The labware repositioning system according to claim 17, wherein the at least one servo motor is mounted to the base plate by standoffs that are connected to the flange and the base plate.

19. The labware repositioning system according to claim 18, wherein the labware nest assembly is a plate nest assembly.

20. The labware repositioning system according to claim 19, wherein the controller is configured to rotate the labware nest assembly and the labware positioned thereon to any desired number of rotational positions.

21. The labware repositioning system according to claim 16, wherein the labware repositioning system is configured to be mounted to, and operated as part of, a robotic liquid handling system.

22. A robotic liquid handling system comprising:
a plurality of labware repositioning systems, each labware repositioning system including:
a servo motor having a rotatable shaft, the rotatable shaft having a longitudinal axis;
a cylindrical hub;
a labware nest assembly having a surface configured to hold a labware, and connected to the rotatable shaft;
wherein the cylindrical hub is mounted to the rotatable shaft and to the labware nest assembly;
a controller operatively connected to the servo-motor and configured to control rotation of the rotatable shaft, and the attached labware nest assembly, wherein the controller is configured to rotate the labware nest assembly to any desired number of rotational positions;
a base plate, wherein at least one servo motor is mounted to the base plate;
an infrared sensor mounting plate mounted to the flange of the servo motor by standoffs that are connected to the flange and the infrared sensor mounting plate;
an infrared sensor mounted to the infrared sensor mounting plate, wherein the infrared sensor includes a body having a first arm and a second arm, and is connected to an optical encoder;
an alignment rod mounted to one of the labware nest assembly and the cylindrical hub, wherein the alignment rod extends transversely from the longitudinal axis of the servo motor and is configured to pass between the first and second arms of the infrared sensor when the hub and the attached labware nest assembly are caused to rotate; wherein in operation the controller is programmed to rotate the servo motor such that the labware positioned in the labware nest assembly is rotated about the longitudinal axis of the servo motor to any desired angular position relative to a longitudinal axis of the base plate, in either a clockwise or counterclockwise direction, and for any desired duration of time; and
wherein in operation as the rotatable shaft of the servo motor rotates, the alignment rod passes between the first and second arms of the infrared sensor, thus allowing the connected optical encoder to define a reference point that establishes a home position for the labware nest assembly and the labware positioned therein; and
a power supply connected to the servo motor, the controller, and the infrared sensor.

23. The robotic liquid handling system according to claim 22:
wherein each servo motor includes a motor body having a flange at a first end thereof;
wherein the servo motor body includes an electrical power port for connection to the power supply, and an encoder port for connection to the controller; and
wherein each servo motor is mounted to the base plate by standoffs that are connected to the flange and the base plate.
